(19) United States
(12) Patent Application Publication
(10) Pub. No.: US 2023/0347769 A1
(43) Pub. Date: Nov. 2, 2023

(54) Tesla (EV) Home or Roadside Charger Powered by Hydrogen Gas

(71) Applicant: Ken Bailey, Boca Raton, FL (US)

(72) Inventor: Kenneth Stephen Bailey, Boca Raton, FL (US)

(21) Appl. No.: 18/072,535

(22) Filed: Nov. 30, 2022

Related U.S. Application Data
(60) Provisional application No. 63/340,420, filed on May 10, 2022.

(51) Int. Cl. B60L 53/31; H02J 3/00; H01M 8/0656; H01M 8/10; H01M 16/00

(52) U.S. Cl. CPC B60L 53/31; H02J 3/00; H01M 8/0656; H01M 8/10; H01M 16/006; H01M 2250/10; H01M 2008/1095

(57) ABSTRACT

It is estimated that by 2030 there will be 145 million EV's in the world, and by 2050 there will be 2.21 Billion Electric Vehicles. These vehicles will require both at home and roadside charging stations for various EV cars and trucks totaling 1.2 million locations just in the State of California alone. The greatest demand will be along remote freeway locations between Las Vegas and Los Angeles such as the Interstate 5 Fwy and the Interstate 15 Fwy. Next year the following car manufacturers are rolling out EV's to meet the surge in demand: Hyundai, Porche, Audi, Nissan, Mazda, Honda, BMW, KIA, Volkswagon, Ford, and Chevy.

The present invention describes a system powered by hydrogen gas that can meet this high demand without running power lines everywhere to support roadside and remote charging.

The system comprises a hydrogen electrolyzer powered by hydrogen made and stored on site and on demand, to create the needed hydrogen from water at each site to meet the required energy needs. This without costly cabling from the power grid or costly wiring underground from the local power company grid location to the remote site. The power stations will be self sufficient with water (even gray water) as the feed stock. The electric catalyst will be minimal solar power to make and store the hydrogen gas.

This application claims benefit of Provisional Application 63/340,420 filed May 10, 2022. This invention relates to the creation of electricity in remote locations to charge EV's on a global basis, utilizing hydrogen gas as the charging source of energy. A charging station, also called an EV charger or electric vehicle supply equipment (EVSE), is a piece of equipment that supplies electrical power for charging plug-in electric vehicles (including hybrids, neighborhood electric vehicles, trucks, buses, and others). Although batteries can only be charged with DC power, most electric vehicles have an onboard AC-to-DC converter that allows them to be plugged into a standard household AC electrical receptacle. Inexpensive low-power public charging stations will also provide AC power, known as “AC charging stations”. To facilitate higher power charging, which requires much larger AC-to-DC converters, the converter is built into the charging station instead of the vehicle and the station supplies already-converted DC power directly to the vehicle, bypassing the vehicle's onboard converter. These are known as “DC charging stations”. Most fully electric car models can accept both AC and DC power. Charging stations provide connectors that conform to a variety of standards. DC charging stations are commonly equipped with multiple connectors to be able to supply a wide variety of vehicles.

### BACKGROUND OF THE INVENTION

Public charging stations are typically found street-side or at retail shopping centers, government facilities, and other parking areas.

Multiple standards have been established for charging technology to enable interoperability across vendors. Standards are available for nomenclature, power and connectors. Notably, Tesla has developed proprietary technology in these areas.

The European Automobile Manufacturers Association (ACEA) has defined the following terms:
Socket outlet: the port on the electric vehicle supply equipment (EVSE) that supplies charging power to the vehicle
Plug: the end of the flexible cable that interfaces with the socket outlet on the EVSE. In North America, the socket outlet and plug are not used because the cable is permanently attached to the EVSE.
Cable: a flexible bundle of conductors that connects the EVSE with the electric vehicle
Connector: the opposite end of the flexible cable that interfaces with the vehicle inlet
Vehicle inlet: the port on the electric vehicle that receives charging power

The terms “electric vehicle connector” and “electric vehicle inlet” were previously defined in the same way under Article 625 of the National Electric Code (NEC) of 1999. NEC-1999 also defined the term “electric vehicle supply equipment” as the entire unit “installed specifically for the purpose of delivering energy from the premises wiring to the electric vehicle”, including “conductors . . . electric vehicle connectors, attachment plugs, and all other fittings, devices, power outlets, or apparatuses”.

### Voltage and Power

The National Electric Transportation Infrastructure Working Council (IWC) was formed in 1991 by the Electric Power Research Institute with members drawn from automotive manufacturers and the electric utilities to define standards in the United States; early work by the IWC led to the definition of three levels of charging in the 1999 National Electric Code (NEC) Handbook.

Under NEC-1999, Level 1 charging equipment was connected to the grid through a standard NEMA 5-20R 3-prong electrical outlet with grounding, and a ground-fault circuit interrupter was required within 12 in (300 mm) of the plug. The supply circuit required protection at 125% of maximum rated current, so for instance charging equipment rated at 16 A continuous current required a breaker sized to 20 Amps.

Level 2 charging equipment was permanently wired and fastened at a fixed location under NEC-1999. It also required grounding and ground-fault protection; in addition, it required an interlock to prevent vehicle startup during charging and a safety breakaway for the cable and connector. A 40 A breaker (125% of continuous maximum supply current) was required to protect the branch circuit. For convenience and speedier charging, many early EVs preferred that owners and operators install Level 2 charging equipment, which was connected to the EV either through an inductive paddle (Magne Charge) or a conductive connector (AVCON).

Level 3 charging equipment used an off-vehicle rectifier to convert the input AC power to DC, which was then supplied to the vehicle. A 500 A breaker (125% of continuous maximum supply current) was required to protect the branch circuit. At the time it was written, NEC-1999 anticipated that Level 3 charging equipment would require utilities to upgrade their distribution systems and transformers.

### SAE

The Society of Automotive Engineers (SAE International) defines the general physical, electrical, communication and performance requirements for EV charging systems used in North America, as part of standard SAE J1772. SAE J1772 defines four levels of charging, two levels each for AC and DC supplies; the differences between levels are based upon the power distribution type, standards and maximum power. Alternating current (AC) AC charging stations connect the vehicle's onboard charging circuitry directly to the AC supply.
AC Level 1: Connects directly to a standard 120 V North American residential outlet; capable of supplying 6-16 A (0.7-1.92 kW) depending on the capacity of a dedicated circuit.
AC Level 2: Utilizes 240 V residential or 208 V commercial power to supply between 6 and 80 A (1.4-19.2 kW). It provides a significant charging speed increase over Level 1 AC charging.

### Direct Current (DC)

Commonly, though incorrectly, called “Level 3” charging based on the older NEC-1999 definition, DC charging is categorized separately in the SAE standard. In DC fast-charging, grid power is passed through an AC-to-DC rectifier before reaching the vehicle's battery, bypassing any onboard rectifier.
DC Level 1: Supplies a maximum of 80 kW at 50-1000 V.
DC Level 2: Supplies a maximum of 400 kW at 50-1000 V.

Additional standards released by SAE for charging include SAE J3068 (three-phase AC charging, using the Type 2 connector defined in IEC 621%-2) and SAE J3105 (automated connection of DC charging devices).

### IEC

The International Electrotechnical Commission (IEC) adopted a majority of the SAE J1772 standard under IEC 62196-1 for international implementation.

The IEC alternatively defines charging in modes (IEC 61851-1):
Mode 1: slow charging from a regular electrical socket (single- or three-phase AC)
Mode 2: slow charging from a regular AC socket but with some EV-specific protection arrangement (i.e. the Park & Charge or the PARVE systems)
Mode 3: slow or fast AC charging using a specific EV multi-pin socket with control and protection functions (i.e. SAE J1772 and IEC 62196-2)
Mode 4: DC fast charging using a specific charging interface (i.e. IEC 621%-3, such as CHAdeMO)

The connection between the electric grid and “charger” (electric vehicle supply equipment) is defined by three cases (IEC 61851-1):
Case A: any charger connected to the mains (the mains supply cable is usually attached to the charger) usually associated with modes 1 or 2.
Case B: an on-board vehicle charger with a mains supply cable that can be detached from both the supply and the vehicle—usually mode 3.
Case C: DC dedicated charging station. The mains supply cable may be permanently attached to the charge station as in mode 4.

### Tesla

In North America, Tesla vehicles use a proprietary charging port; to meet EU requirements on recharging points, Tesla vehicles sold there are equipped with an CCS Combo 2 port. Either port will take 480 V DC fast charging through its network of Tesla Superchargers. Depending on the Supercharger version, power is supplied at 72, 150, or 250 kW, corresponding to DC Levels 1 and 2 of SAE J1772. For a Tesla Model S, a supercharger can add around 275 km (170 miles) of range in about 30 minutes. As of Q4 2021, Tesla reported 3,476 supercharging stations.

### Future Development

An extension to the CCS DC fast-charging standard for electric cars and light trucks is under development, which will provide higher power charging for large commercial vehicles (Class 8, and possibly 6 and 7 as well, including school and transit buses). When the CharIN task force was formed in March 2018, the new standard being developed was originally called High Power Charging for Commercial Vehicles (HPCCV), later renamed Megawatt Charging System (MCS). MCS is expected to operate in the range of 200-1500 V and 0-3000 A for a theoretical maximum power of 4.5 MW. The proposal calls for MCS charge ports to be compatible with existing CCS and HPC chargers. The task force released aggregated requirements in February 2019, which called for maximum limits of 1000 V DC (optionally, 1500 V DC) and 3000 A continuous rating. A connector design was selected in May 2019 and tested at the National Renewable Energy Laboratory (NREL) in September 2020. Thirteen manufacturers participated in the test, which checked the coupling and thermal performance of seven vehicle inlets and eleven charger connectors. The final connector requirements and specification are expected to be released in late 2021. With support from Portland General Electric, on 21 Apr. 2021 Daimler Trucks North America opened the “Electric Island”, the first heavy-duty vehicle charging station, across the street from its headquarters in Portland, Oregon. The station is capable of charging eight vehicles simultaneously, and the charging bays are sized to accommodate tractor-trailers. In addition, the design is capable of accommodating >1 MW chargers once they are available. A startup company, WattEV, announced plans in May 2021 to build a 40-stall truck stop/charging station in Bakersfield, California; at full capacity, it would provide a combined 25 MW of charging power, partially drawn from an on-site solar array and battery storage.

### Connectors

Common connectors include Type 1 (Yazaki), Type 2 (Mennekes), Type 3 (Scame), CCS Combo 1 and 2, CHAdeMO, and Tesla. Many standard plug types are defined in IEC 62196-2 (for AC supplied power) and 62196-3 (for DC supplied power):
Type 1: single-phase AC vehicle coupler—SAE J1772/2009 automotive plug specifications
Type 2: single- and three-phase AC vehicle coupler—VDE-AR-E 2623-2-2, SAE J3068, and GB/T 20234.2 plug specifications
Type 3: single- and three-phase AC vehicle coupler equipped with safety shutters—EV Plug Alliance proposal
Type 4: DC fast charge couplers

CCS DC charging requires Powerline Communications (PLC). Two connectors are added at the bottom of Type 1 or Type 2 vehicle inlets and charging plugs to supply DC current. These are commonly known as Combo 1 or Combo 2 connectors. The choice of style inlets is normally standardized on a per-country basis so that public chargers do not need to fit cables with both variants. Generally, North America uses Combo 1 style vehicle inlets, while most of the rest of the world uses Combo 2.

The CHAdeMO standard is favored by Nissan, Mitsubishi, and Toyota, while the SAE J1772 Combo standard is backed by GM, Ford, Volkswagen, BMW, and Hyundai. Both systems charge to 80% in approximately 20 minutes, but the two systems are completely incompatible. Richard Martin, editorial director for clean technology marketing and consultant firm Navigant Research, stated:

The broader conflict between the CHAdeMO and SAE Combo connectors, we see that as a hindrance to the market over the next several years that needs to be worked out.

### Historical Connectors

In the United States, many of the EVs first marketed in the late 1990s and early 2000s such as the GM EV1, Ford Ranger EV, and Chevrolet S-10 EV preferred the use of Level 2 (single-phase AC) EVSE, as defined under NEC-1999, to maintain acceptable charging speed. These EVSE were fitted with either an inductive connector (Magne Charge) or a conductive connector (generally Avcon). Proponents of the inductive system were GM, Nissan, and Toyota; DaimlerChrysler, Ford, and Honda backed the conductive system.

Magne Charge paddles were available in two different sizes: an older, larger paddle (used for the EV1 and S-10 EV) and a newer, smaller paddle (used for the first-generation Toyota RAV4 EV, but backwards compatible with large-paddle vehicles through an adapter). The larger paddle (introduced in 1994) was required to accommodate a liquid-cooled vehicle inlet charge port; the smaller paddle (introduced in 2000) interfaced with an air-cooled inlet instead. SAE J1773, which described the technical requirements for inductive paddle coupling, was first issued in January 1995, with another revision issued in November 1999. The influential California Air Resources Board adopted the conductive connector as its standard on 28 Jun. 2001, based on lower costs and durability, and the Magne Charge paddle was discontinued by the following March. Three conductive connectors existed at the time, named according to their manufacturers: Avcon (aka butt-and-pin, used by Ford, Solectria, and Honda); Yazaki (aka pin-and-sleeve, on the RAV4 EV); and ODU (used by DaimlerChrysler). The Avcon butt-and-pin connector supported Level 2 and Level 3 (DC) charging and was described in the appendix of the first version (1996) of the SAE J1772 recommended practice; the 2001 version moved the connector description into the body of the practice, making it the de facto standard for the United States. IWC recommended the Avcon butt connector for North America, based on environmental and durability testing. As implemented, the Avcon connector used four contacts for Level 2 (L1, L2, Pilot, Ground) and added five more (three for serial communications, and two for DC power) for Level 3 (L1, L2, Pilot, Com1, Com2, Ground, Clean Data ground, DC+, DC−). By 2009, J1772 had instead adopted the round pin-and-sleeve (Yazaki) connector as its standard implementation, and the rectangular Avcon butt connector was rendered obsolete.

### Charging Time

Charging time basically depends on the battery's capacity, power density, and charging power. The larger the capacity, the more charge the battery can hold (analogous to the size of a fuel tank). Higher power density allows the battery to accept more charge/unit time (the size of the tank opening). Higher charging power supplies more energy per unit time (analogous to a pump's flow rate). An important downside of charging at fast speeds is that it also stresses the mains electricity grid more.

California Air Resources Board specified a target to qualify as a zero-emission vehicle: add 200 miles (320 km) in under 15 minutes. The intent was to match the refueling expectations of internal combustion engine drivers.

The effective charging power can be lower than the maximum charging power due to limitations of the battery or battery management system, charging losses (which can be as high as 25%), and vary over time due to charging limits applied by a charge controller.

### Battery Capacity

The usable battery capacity of a first-generation electric vehicle, such as the original Nissan Leaf, was about 20 kWh, giving it a range of about 100 m (160 km). Tesla was the first company to intoduce longer-range vehicles, initially releasing their Model S with battery capacities of 40 kWh 6 kWh and 85 kWh, with the latter lasting for about 480 km (300 mi). Plug-in hybrid vehicles typically have capacity of roughly 3 to 20 kWh, lasting for 20 to 80 kilometers (12 to 50 miles).

### AC to DC Conversion

Batteries are charged with DC power. To charge from the AC power supplied by the electrical grid, EVs have a small AC-to-DC converter built into the vehicle. The charging cable supplies AC power from the wall, and the vehicle converts this power to DC internally and charges its battery. The built-in converters on most EVs typically support charging speeds up to 6-7 kW, sufficient for overnight charging. This is known as “AC charging”. To facilitate rapid recharging of EVs, much higher power (50-100 kW+) is necessary. This requires a much larger AC-to-DC converter which is not practical to integrate into the vehicle. Instead, the AC-to-DC conversion is performed by the charging station, and DC power is supplied to the vehicle directly, bypassing the built-in converter. This is known as DC fast charging.

| Charging time | | | | | |
|---|---|---|---|---|---|
| for 100 km of | | | | | |
| range on a Tesla | | | | | |
| Model S Long | | | | | |
| Range per EPA | | | | | |
| (111 MGPe/ | | | | | |
| (188 Wh/km) | | | | Charging | |
| Configuration | Voltage | Current | Power | time | Comment |
| Single-phase | 120 V | 12 A | 1.44 kW | 13 hours | This is the maximum |
| AC | | | | | continuious power |
| | | | | | available from a |
| | | | | | standard |
| | | | | | US/Canadian |
| | | | | | 120 V 15 A |
| | | | | | circuit |
| Single-phase | 230 V | 12 A | 2.76 kW | 6.8 hours | This is the maximum |
| AC | | | | | continuous power |
| | | | | | available from a CEE |
| | | | | | 7/3 (“Schuko”) |
| | | | | | receptacle on a |
| | | | | | 16 A rated circuit |
| Single-phase | 240 V | 30 A | 7.20 KW | 2.6 hours | Common maxmum |
| AC | | | | | limit of public AC |
| | | | | | charging stations |
| | | | | | used in North America, |
| | | | | | such as a ChargePoint |
| | | | | | CT4000 |
| Three-phase | 400 V | 16 A | 11.0 kW | 1.7 hours | Maximum limit of a |
| AC | | | | | European 16 A three- |
| | | | | | phase AC |
| | | | | | charging station |
| Three-phase | 400 V | 32 A | 22.1 kW | 51 minutes | Maximum limit of a |
| AC | | | | | European 32 A three- |
| | | | | | phase AC |
| | | | | | charging station |
| DC | 400 V | 125 A | 50 kW | 22 minutes | Typical mid-power DC |
| | | | | | charging station |
| DC | 400 V | 300 A | 120 kW | 9 minutes | Typical power |
| | | | | | from a Tesla |
| | | | | | V2 Tesla Super- |
| | | | | | charger |

### Safety

Charging stations are usually accessible to multiple electric vehicles and are equipped with current or connection sensing mechanisms to disconnect the power when the EV is not charging.

The two main types of safety sensor:
Current sensors monitor power consumed, and maintain the connection only while demand is within a predetermined range.
Sensor wires provide a feedback signal such as specified by the SAE J1772 and IEC 62196 schemes that require special (multi-pin) power ping fittings.

Sensor wires react more quickly, have fewer parts to fail, and are possibly less expensive to design and implement. Current sensors however can use standard connectors and can allow suppliers to monitor or charge for the electricity actually consumed.

### Public Charging Stations

### Further Information on the Coordinated Development of Charging Stations in a Region by a Company or Local Government:

Longer drives require a network of public charging stations. In addition, they are essential for vehicles that lack access to a home charging station, as is common in multi-family housing. Costs vary greatly by country, power supplier and power source. Some services charge by the minute, while others charge by the amount of energy received (measured in kilowatt-hours).

Charging stations may not need much new infrastructure in developed countries, less than delivering a new fuel over a new network. The stations can leverage the existing ubiquitous electrical grid.

Charging stations are offered by public authorities, commercial enterprises and some major employers to address range barriers. Options include simple charging posts for roadside use, charging cabinets for covered parking places and fully automated charging stations integrated with power distribution equipment.

As of December 2012, around 50,000 non-residential charging points were deployed in the U.S., Europe, Japan and China. As of August 2014, some 3,869 CHAdeMO quick chargers were deployed, with 1,978 in Japan, 1,181 in Europe and 686 in the United States, and 24 in other countries.

### Asia/Pacific

As of December 2012, Japan had 1,381 public DC fast-charging stations, the largest deployment of fast chargers in the world, but only around 300 AC chargers. As of December 2012, China had around 800 public slow charging points, and no fast charging stations. As of September 2013, the largest public charging networks in Australia were in the capital cities of Perth and Melbourne, with around 30 stations (7 kW AC) established in both cities—smaller networks exist in other capital cities.

### Europe

As of December 2013, Estonia was the only country that had completed the deployment of an EV charging network with nationwide coverage, with 165 fast chargers available along highways at a maximum distance of between 40-60 km (25-37 mi), and a higher density in urban areas.

As of November 2012, about 15,000 charging stations had been installed in Europe.

As of March 2013, Norway had 4,029 charging points and 127 DC fast-charging stations. As part of its commitment to environmental sustainability, the Dutch government initiated a plan to establish over 200 fast (DC) charging stations across the country by 2015. The rollout will be undertaken by ABB and Dutch startup Fastened, aiming to provide at least one station every 50 km (31 mi) for the Netherlands' 16 million residents. In addition to that, the E-laad foundation installed about 3000 public (slow) charge points since 2009. Compared to other markets, such as China, the European electric car market has developed slowly. This, together with the lack of charging stations, has reduced the number of electric models available in Europe. In 2018 and 2019 the European Investment Bank (EIB) signed several projects with companies like Allego, Greenway, BeCharge and Enel X. The EIB loans will support the deployment of the charging station infrastructure with a total of €200 million. The UK government declared that it will ban the selling of new petrol and diesel vehicles by 2035 for a complete shift towards electric charging vehicles.

### North America

As of August 2018, 800,000 electric vehicles and 18,000 charging stations operated in the United States, up from 5,678 public charging stations and 16,256 public charging points in 2013. By July 2020, Tesla had installed 1,971 stations (17,467 plugs).

As of August 2019, in the U.S., there are 2,140 CHAdeMO charging stations (3,010 plugs), 1,888 SAE CCS1 charging stations (3,525 plugs), and 678 Tesla Supercharger stations (6,340 plugs), according to the U.S. Department of Energy's Alternative Fuels Data Center. Colder areas such as Finland, some northern US states and Canada have some infrastructure for public power receptacles provided primarily for use by block heaters. Although their circuit breakers prevent large current draws for other uses, they can be used to recharge electric vehicles, albeit slowly. In public lots, some such outlets are turned on only when the temperature falls below −20° C., further limiting their value.

In 2017, Tesla gave the owners of its Model S and Model X cars 400 kWh of Supercharger credit, although this varied over time. The price ranges from $0.06-0.26/kWh in the United States. Tesla Superchargers are usable only by Tesla vehicles.

Other charging networks are available for all electric vehicles. The Blink network has both AC and DC charging stations and charges separate prices for members and non-members. Their prices range from $0.39-0.69/kWh for members and $0.49-0.79/kWh for non-members, depending on location. The ChargePoint network has free chargers and paid chargers that drivers activate with a free membership card. Prices are based on local rates. Other networks may accept cash or a credit card.

### Africa

South African based ElectroSA and automobile manufacturers including BMW, Nissan and Jaguar have so far been able to install 80 electric car charges nationwide.

### South America

In April 2017 YPF, the state-owned oil company of Argentina, reported that it will install 220 fast-load stations for electric vehicles in 110 of its service stations in the national territory.

### Projects

Electric car manufacturers, charging infrastructure providers, and regional governments have entered into agreements and ventures to promote and provide electric vehicle networks of public charging stations.

The EV Plug Alliance is an association of 21 European manufacturers that proposed an IEC norm and a European standard for sockets and plugs. Members (Schneider Electric, Legrand, Scame, Nexans, etc.) claimed that the system was safer because they use shutters. Prior consensus was that the JEC 621% and IEC 61851-1 standards have already established safety by making parts non-live when touchable.

### Battery Swap

A battery swapping (or switching) station allow vehicles to exchange a discharged battery pack for a charged one, eliminating the charge interval. Battery swapping is common in electric forklift applications.

### History

The concept of an exchangeable battery service was proposed as early as 18%. It was first offered between 1910 and 1924, by Hartford Electric Light Company, through the GeVeCo battery service, serving electric trucks. The vehicle owner purchased the vehicle, without a battery, from General Vehicle Company (GeVeCo), part-owned by General Electric. The power was purchased from Hartford Electric in the form of an exchangeable battery. Both vehicles and batteries were designed to facilitate a fast exchange. The owner paid a variable per-mile charge and a monthly service fee to cover truck maintenance and storage. These vehicles covered more than 6 million miles.

Beginning in 1917, a similar service operated in Chicago for owners of Milburn Electric cars. A rapid battery replacement system was implemented to service 50 electric buses at the 2008 Summer Olympics.

In 1993 Suntera developed a two-seat 3-wheel electric vehicle called the SUNRAY, which came with a battery cartridge that swapped out in minutes at a battery-swap station. In 1995, Suntera added a motor scooter. The company was later renamed Personal Electric Transports (P.E.T.). After 2000 the company developed an electric bus. In 2004, the company's 3-wheel stand-up EV won 1st place at the 5-day long American Tour De Sol electric vehicle race, before closing in 2006.

Better Place, Tesla, and Mitsubishi Heavy Industries considered battery switch approaches. One complicating factor was that the approach requires vehicle design modifications.

In 2013, Tesla announced a proprietary charging station service. A network of Tesla Supercharger stations was envisioned to support both battery pack swaps and fast charging. Tesla later focused exclusively on fast-charging stations.

### Benefits

The following benefits were claimed for battery swapping:
“Refueling” in under five minutes.
Automation: The driver can stay in the car while the battery is swapped.
Switch company subsidies could reduce prices without involving vehicle owners.
Spare batteries could participate in vehicle to grid energy services.

### Providers

The Better Place network was the first modern attempt at the battery switching model. The Renault Fluence Z.E. was the first car enabled to adopt the approach and was offered in Israel and Denmark.

Better Place launched its first battery-swapping station in Israel, in Kiryat Ekron, near Rehovot in March 2011. The exchange process took five minutes. Better Place filed for bankruptcy in Israel in May 2013.

In June 2013, Tesla announced its plan to offer battery swapping. Tesla showed that a battery swap with the Model S took just over 90 seconds. Elon Musk said the service would be offered at around US$60 to US$80 at June 2013 prices. The vehicle purchase included one battery pack. After a swap, the owner could later return and receive their battery pack fully charged. A second option would be to keep the swapped battery and receive/pay the difference in value between the original and the replacement. Pricing was not announced. In 2015 the company abandoned the idea for lack of customer interest. Other battery swapping service providers include Gogoro, Delta Electronics, BattSwap, and Voltia. As of March 2022, NIO has 836 swap stations in China, up from 131 in 2020. A station can cost $772,000 in China. A 90 kWh battery is charged at 60 kW and can be swapped in 6 minutes. China operates cement trucks where the heavy battery is swapped. A battery swap system with a 2 MWh battery in each 20-foot shipping container powering a converted canal barge began operating in the Netherlands in 2021.

### Criticism

Battery swapping solutions were criticized as proprietary. By creating a monopoly regarding the ownership of the batteries and the patent protected technologies the companies split up the market and decrease the chances of a wider usage of battery swapping.

### Sites

Charging stations can be placed wherever electric power and adequate parking are available. Residences are by far the most common charging location. Home charging stations typically lack user authentication and separate metering, and may require a dedicated circuit. Some portable charging cable can be wall mounted. In addition to home stations, public stations have been sited along highways, in shopping centers, hotels, government facilities and at workplaces. Some gas stations offer EV charging stations. Some charging stations have been criticized as inaccessible, hard to find, out of order, and slow, thus slowing EV adoption.

Public charge stations may charge a fee or offer free service based on government or corporate promotions. Charge rates vary from residential rates for electricity to many times higher, the premium is usually for the convenience of faster charging. Vehicles can typically be charged without the owner present, allowing the owner to partake in other activities. Sites include malls, freeway rest stops, transit stations, government offices, etc. Typically, AC Type 1/Type 2 plugs are used. Mobile charging involves another vehicle that brings the charge station to the Electric vehicle, the power is supplied via a fuel generator (typically gasoline or diesel), or a large battery. Wireless charging uses inductive charging mats that charge without a wired connection and can be embedded in parking stalls or even on roadways.

An offshore electricity recharging system named Stillstrom, to be launched by Danish shipping firm Maersk Supply Service, will give ships access to renewable energy while at sea. Connecting ships to electricity generated by offshore wind farms, Stillstrom is designed to cut emissions from idling ships.

The E-Move Charging Station is equipped with eight monocrystalline solar panels, which can supply 1.76 kW of solar power.

In 2012, Urban Green Energy introduced the world's first wind-powered electric vehicle charging station, the Sanya SkyPump. The design features a 4 kW vertical-axis wind turbine paired with a GE WattStation.

In 2021 Nova Innovation introduced the world's first direct from tidal power EV charge station. World's first tidal energy powered EV charger launched in Shetland.

### Smart Grid

A smart grid is one that can adapt to changing conditions by limiting service or adjusting prices. Some charging stations can communicate with the grid and activate charging when conditions are optimal, such as when prices are relatively low. Some vehicles allow the operator to control recharging. Vehicle-to-grid scenarios allow the vehicle battery to supply the grid during periods of peak demand. This requires communication between the grid, charging station, and vehicle. SAE International is developing related standards. These include SAE J2847/1. ISO and IEC are developing similar standards known as ISO/IEC 15118, which also provide protocols for automatic payment.

### Renewable Energy

Charging stations are typically connected to the grid, which in most jurisdictions relies on fossil-fuel power stations. However, renewable energy may be used to reduce the use of grid energy. Nidec Industrial Solutions has a system that can be powered by either the grid or renewable energy sources like PV. In 2009, SolarCity marketed its solar energy systems for charging installations. The company announced a single demonstration station in partnership with Rabobank on Highway 101 between San Francisco and Los Angeles.

The E-Move Charging Station is equipped with eight monocrystalline solar panels, which can supply 1.76 kW of solar power.

In 2012, Urban Green Energy introduced the world's first wind-powered electric vehicle charging station, the Sanya SkyPump. The design features a 4 kW vertical-axis wind turbine paired with a GE WattStation.

In 2021 Nova Innovation introduced the world's first direct from tidal power EV charge station. World's first tidal energy powered EV charger launched in Shetland.

### Specifications

In the present invention the teachings relate to Electric Vehicle regional and remote charging stations whose energy is derived from Green Hydrogen. The system is comprised of a water storage tank, a water pump, a hydrogen fuel cell, a solar array, a capacitor, an DC to AC convertor, an alternator, a system interface, and a regulator with off site monitoring capability.

The system acts to create hydrogen from distilled water through a fuel cell that creates semi-conductor grade hydrogen which can be used to turn an electric alternator thereby creating electricity to charge an EV car or truck. The system has few moving parts and does therefore not require regular maintenance. The lifecycle of the system is in years. The byproduct of the system is water vapor and super oxygenated water.

An average TESLA as of Feb. 28, 2022 utilizes 34 KWh of electricity to power the car 100 miles. A typical Tesla averages 1,500 Miles Per Month at a cost to charge of 45.00 per month per household if charging at home. The charging rate is 30 miles for every hour of charging. If you try to use your Tesla to power your house with electricity it voids the Tesla warranty. Our system installed into an average home could be used to charge the car and when not in use as a charger, then also power ones home with Federal U.S. tax incentives.

### A BRIEF DESCRIPTIONS OF THE DRAWINGS

FIG. 1 depicts the end to end system components that might be found in the preferred embodiment of the present invention for example.

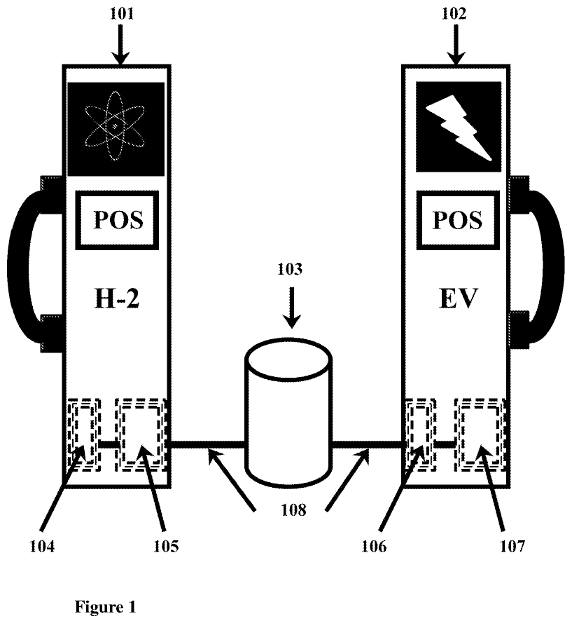

FIG. 2 depicts the control software that is resident in the system and the flow control as might be found in the preferred embodiment of the present invention.

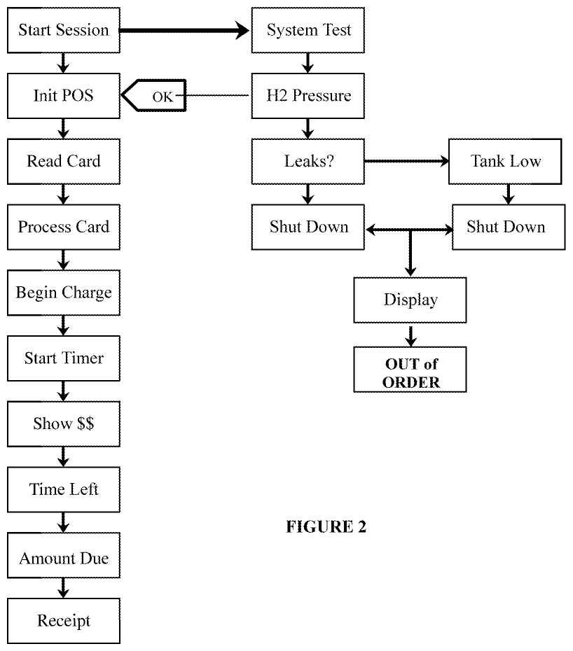

FIG. 3 depicts an aerial depiction of the site as might be found in the preferred embodiment of the present invention for example.

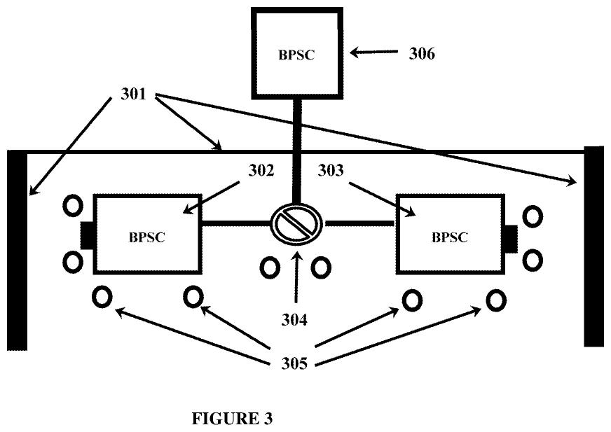

I claim:

1. A roadside self-sufficient charging and refueling kiosk for both refueling hydrogen powered cars and trucks as well as an Electric Vehicle (EV) charger both of which are powered or fueled by an onsite PEM type fuel cell which creates energy on demand from battery power utilized to convert water into semiconductor grade hydrogen gas which at the same time is used to trickle charge the batteries used to create the process without the need for any external power other than batteries which create additional hydrogen gas, when not being used to refuel hydrogen powered vehicles or recharge electric battery powered vehicles (EV's).

2. Claim 1. Further comprising the system can be used for providing electrical power for safety lighting, cleaning and sanitation needs for restroom facilities, and overnight camping, such as an RV or motorhome parking facility.

3. Claim 1 further comprising a means of providing electricity for cellular phone network relay stations or cell towers as required for first responders or critical infrastructure communications either public or private or Government usage.

4. Claim 1 further comprising electric power for any purpose on an emergency limited basis or for prime power needs and requirements on a 24/7 basis as needed.
